(19) United States
(12) Patent Application Publication
(10) Pub. No.: US 2005/0133378 A1
(43) Pub. Date: Jun. 23, 2005

(54) Method and device for removing metallic material of a workpiece

(76) Inventors: Armin Glock, Urbach (DE); Juergen Hackenberg, Sachsenheim (DE)

Correspondence Address: KENYON & KENYON, ONE BROADWAY, NEW YORK, NY, 10004, US

(21) Appl. No.: 11/018,955

(22) Filed: Dec. 20, 2004

(30) Foreign Application Priority Data
Dec. 20, 2003 (DE) 103 60 080.9

(51) Int. Cl. B23H 7/26

(52) U.S. Cl. 205/651

(57) ABSTRACT

A method for removing metallic material of a workpiece, using the flow of current between an electrode and the workpiece in the presence of an electrolyte. In this context, a relative movement occurs between the electrode and the workpiece as a function of time. In addition, it is provided that at least one further process parameter be regulated and/or changed as a function of time.

### FIELD OF INVENTION

The present invention relates to a method for removing metallic material of a workpiece and a device for implementing the method.

### BACKGROUND INFORMATION

Electrochemical methods, inter alia, are used for machining or patterning surfaces of metallic workpieces. These so-called electrochemical machining processes (ECM) are based on removing metallic material of the workpiece surface to be patterned. To this end, the workpiece is wired as an anode and dipped into an electrolyte solution. A sufficiently high voltage is applied, i.e., a sufficiently large current is conducted, between the workpiece that is contacted as an anode and an electrode taking the form of a separate cathode. These measures allow material to be removed at the workpiece.

Until now, such ECM processes have been predominantly used for patterning or fine-patterning surfaces, which have optionally been roughly pre-patterned with the aid of a different removal method.

European Patent No. EP 352 926 A1 describes a method for producing a fuel injector. In this connection, holes are formed by electro-erosive machining from outside the nozzle, using an electrode which is precision-guided, so that it follows a conical trajectory about the axis of the hole.

Electrodes for such erosive machining processes (EDM) are relatively expensive to produce and are subjected to considerable wear during the EDM boring process. Against this background, injectors having a complex spray orifice geometry may not be manufactured using conventional methods such as erosive machining, laser drilling, microgalvanic drilling, and the like, or may only be manufactured at great expense using the conventional methods.

A method and a device for an ECM process are described in U.S. Pat. No. 6,290,461 B1. The device has at least two electrodes, whose surfaces are partially coated with insulation. Such a coating has a pattern, by which the removal of material at a workpiece to be machined is qualitatively controlled, when the at least one electrode is positioned in an opening of the workpiece. In this connection, it is provided that this ECM method be optimized, using a stream of electrolyte solution that may only be controlled at additional expense and with less accuracy.

### SUMMARY

An object of the present invention is to improve the removal of metallic material of a workpiece, in order to produce, for example, a fuel injector.

An example method of the present invention for removing metallic material of a workpiece is implemented using the flow of current between an electrode and the workpiece in the presence of an electrolyte. In this context, a time-dependent relative movement occurs between the electrode and the workpiece. In addition, it is provided that at least one further process parameter be regulated and/or changed as a function of time. The relative movement occurs continuously and/or discontinuously.

According to the present invention, an ECM sinking method may be implemented, which is superposed with a time-dependent, pulse-ECM process as a function of the required hole geometry. The relative movement occurring as a function of time may be superimposed with a minimal oscillation of the electrode relative to the workpiece, which promotes the thorough mixing of the electrolyte. During this movement, the at least one additional process parameter is changed at different times, which means that hole geometries, e.g., different radii, are qualitatively and quantitatively controlled.

Provided as the at least one additional, time-dependent, controllable and/or changeable process parameter is an electromagnetic quantity accompanying the example method of the present invention, such as a current that flows between the electrode and the workpiece or a voltage that is applied between the workpiece and the electrode.

The example method of the present invention allows a desired removal geometry to be produced in the workpiece, i.e., inside the workpiece, by suitably guiding the electrode relative to the workpiece and/or guiding the workpiece relative to the electrode. In this connection, it is provided that the electrode works its way into the workpiece or performs rough-machining inside the workpiece at a suitable tempo, e.g., as a function of the material removal. This is typically accomplished in a contact-free manner. Consequently, the workpiece may be machined and shaped so as to satisfy high technical requirements.

The measures of the present invention allow an ECM process to be controlled in such a manner that metallic material is removed inside the workpiece in a highly precise manner. In this context, it is possible to control, regulate, and/or change the time-dependent relative movement in connection with the flowing current and/or the applied voltage in a coordinated manner or simultaneously.

Different variants for implementing the method of the present invention are possible. For example, it is possible for the electrode to be moved at a constant speed relative to the workpiece, so that it is possible to remove metallic material inside an orifice of the workpiece in a substantially homogeneous manner, in order to produce a hole having an equidistant diameter.

In the case of a discontinuous relative movement between the electrode and the workpiece, it is also possible, of course, to stop the electrode for a period of time but continue the ECM process. When the electrode is stopped while the current and/or voltage is possibly changed in a continuous or discontinuous manner, the diameter may be changed in places inside the hole, or a wall of the hole may be molded (deformed), so that hollows are produced inside the hole.

In a preferred refinement of the example method according to the present invention, it is provided that the electrode be moved in a direction perpendicular to a surface of the workpiece. The measures of the present invention allow the hole to have, inside the workpiece, e.g., a first opening having a first diameter and a second opening having a second diameter.

In this manner, a channel for a flowing medium, preferably a fuel injector, may be produced inside the workpiece. Such fuel injectors ideally have a conical shape. Holes or channels having an appropriate, conical shape may be produced in a particularly simple manner by suitably guiding the electrode.

Fuel injectors aid in the delivery of fuel in internal combustion engines of vehicles. Their geometry influences the jet shape and droplet size of the fuel. The fuel injectors manufactured according to the present invention minimize the coking tendency (depositing) of the fuel. In the case of apertured spray disks for injecting fuel, the method of the present invention allows additional degrees of freedom to be attained when adjusting the sizes of the droplets.

Of course, the example method of the present invention also allows removal geometries other than holes or channels to be produced. The shape of the removal geometry is additionally influenced by the shape of the electrode or of a part of the electrode.

Therefore, the electrode may advantageously be conical. This measure allows a desired, conical form of the hole or the channel to be promoted, in that the electrode is contactlessly guided into the workpiece at a suitable speed, with accompanying material removal and increasing widening of the hole (ECM sinking method).

For this reason, an embodiment of the present invention provides that a current/voltage source for supplying the flow of current generate a DC current or a pulsed current. It is also possible to superpose a constant DC current with current pulses. In this manner, the current density prevailing at a workpiece surface to be removed is varied. The amount of removed material is a function of this current density.

The removal geometry is controlled by moving the electrode at different speeds relative to the workpiece, or even by stopping it. The longer the electrode stays at a position of the workpiece, or the more slowly this position is passed, the more material that is removed there.

Using an electrode that is insulated in places, various structural effects may be produced inside a preformed removal geometry, e.g., inside a cylindrical hole produced by the ECM sinking method of the present invention. If an electrode partially coated with electrically insulating material is moved inside the hole as a function of time and the ECM method is implemented, then material is removed only from those spots of the workpiece, which are situated in the vicinity of a region of the electrode that has no insulation.

Therefore, the present invention allows a variable amount of material to be removed inside or along the wall of a hole, using the current of the ECM process and/or the speed of the relative movement between the workpiece and the electrode and/or the structural shape of the electrode. All of these measures influence the geometry of the machined workpiece both quantitatively and qualitatively. Consequently, hollows, in particular, may also be produced inside a hole.

Producing a removal geometry with the aid of the ECM process according to the present invention is substantially better than producing it with the aid of corrosive machining according to the related art. The electrode for the ECM process is not subjected to any wear.

In addition, spray orifices produced according to the method of the present invention may also be of interest for spray-orifice applications outside the automotive area, such as for nozzles of ink-jet printers, or for spray orifices when applying paint and spray-cleaning.

The device of the present invention for removing metallic material of a workpiece, using the flow of current between an electrode and the workpiece in the presence of an electrolyte, has a current/voltage source for producing the flow of current. This current/voltage source is connected to the electrode and the workpiece. In addition, the device of the present invention has a reservoir for providing the electrolyte between the electrode and the workpiece, and at least one device for producing a time-dependent relative movement between the electrode and the workpiece, and at least one device for regulating the current/voltage source as a function of time.

Further advantages and refinements of the present invention come to light from the description and the accompanying figures.

It goes without saying that the features indicated above or yet to be clarified in the following are usable not only in the combination specified in each instance, but also in other combinations or by themselves, without departing from the scope of the present invention.

### BRIEF DESCRIPTION OF THE DRAWINGS

The present invention is schematically represented in the figures with reference to exemplified embodiments, and is described in detail below with reference to the figures.

FIGS. 1 and 2 show schematic representations of different variants for producing conical holes.

FIGS. 3 and 4 show schematic representations of different variants for producing complex conical holes.

FIG. 5 shows a schematic representation of an advantageous embodiment of a result of the method according to the present invention.

FIG. 6 shows a schematic representation of a further refinement of an electrode, as well as a hole that may be produced by it.

### DETAILED DESCRIPTION OF EXAMPLE EMBODIMENTS

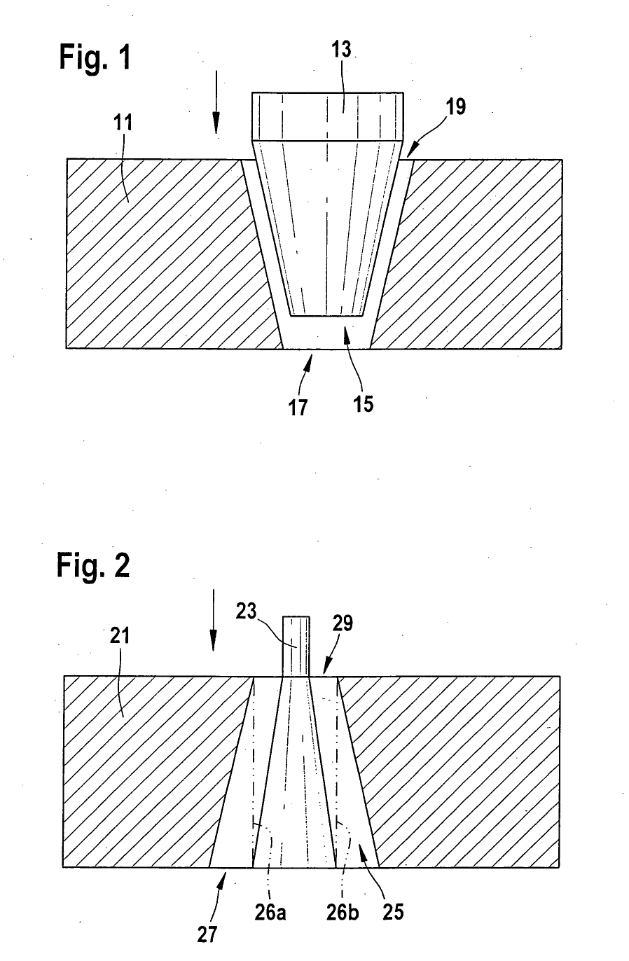

FIG. 1 shows a workpiece 11 having a hole 15 that includes a first opening 19 and a second opening 17, as well as an electrode 13 that is conically shaped at its tip. To execute the method of the present invention, electrode 13 is moved in the direction of the arrow.

Conical spray orifice 15 is produced from the end of first opening 19 (large spray-orifice diameter), using the ECM-sinking machining of the present invention. In this variant, the shape of hole 15 is influenced by the shape of electrode 13.

FIG. 2 shows a workpiece 21 having a hole 25 that includes a first opening 29 and a second opening 27, as well as an electrode 23 that is moved in the direction of the arrow to implement the method of the present invention.

A conical spray orifice 15 is produced in FIG. 2, just as in FIG. 1. In this case, the machining is carried out from the end of opening 27 having the small spray-aperture diameter. In this connection, a cylindrical hole delimited by dashed lines 26a, 26b is initially produced with the aid of the ECM-sinking machining of the present invention. Electrode 23 conically widened in its front region then remains inside this hole in a fixed position and enlarges it in a uniformly conical manner to form final spray orifice 25, using pulse-ECM-machining.

As FIGS. 1 and 2 clearly show, both large positive and large negative k factors may be produced by the method according to the present invention. This may occur regardless of the direction in which a relative movement between workpiece 11, 21 and electrode 13, 23 occurs, whether working from an inlet or outlet end (first or second opening 17, 27, 19, 29) of spray orifice 15, 25. (In the case of conical spray orifices, the k factor is defined as the difference between the inlet diameter and the outlet diameter, divided by 10.)

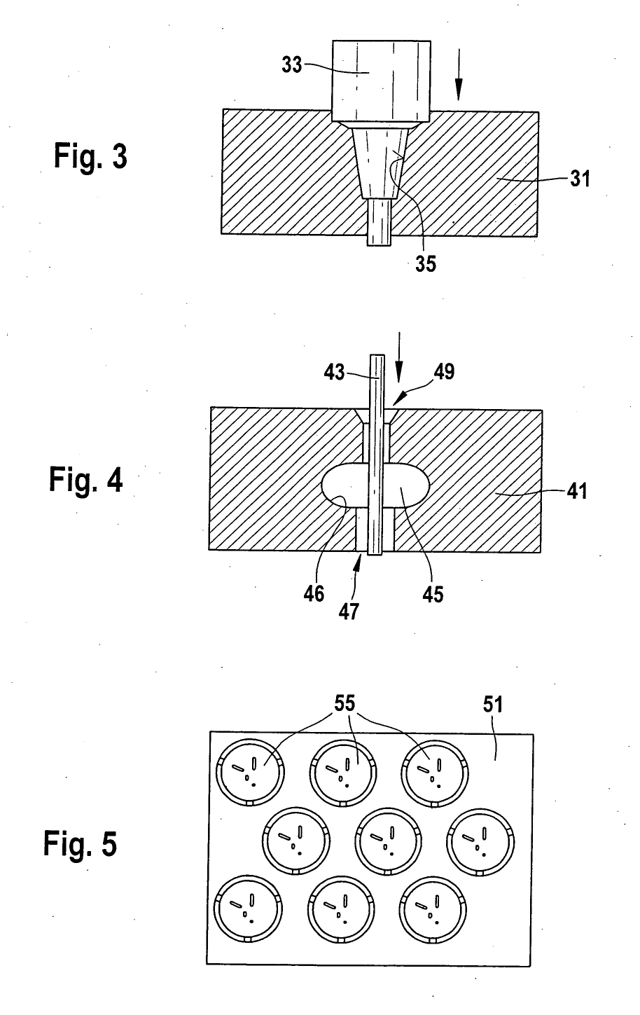

FIG. 3 shows a workpiece 31 having a hole 35, as well as an electrode 33 that is moved in the direction of the arrow to execute the example method of the present invention. In this case, it is also shown to what extent a possible, specific embodiment of electrode 33 may influence the geometry of hole 35. The shape of hole 35 is distinguished in that it is a combination of several geometries, such as conical regions of different radii, steps, and a cylindrical section.

At this point, it should be mentioned that the cross-section of a hole does not have to be circular. When implementing the method of the present invention, any other geometries may also be produced. By this means, a variable wall contour of hole 35 and a diameter that changes over the depth of the hole may be produced.

FIG. 4 shows a workpiece 41 having a hole 45 that includes a first opening 49 and a second opening 47, as well as an electrode 43 that is moved in the direction of the arrow to implement the method of the present invention. In this exemplary embodiment, it is provided that electrode 43 be partially insulated.

The shape of the hole 45 produced here, which has, inter alia, a hollow 46, may be produced by varying current density, feed rate, and/or design of the electrode. Therefore, both positive and negative k factors may be produced.

By introducing electrode 43 into workpiece 41 while carrying out an ECM process, a largely cylindrical hole is initially preformed. Due to the insulation that is present in sections along electrode 43, additional removal by means of ECM machining occurs only in sections along the preformed cylindrical hole, which ultimately results in the structure of hole 45.

This specific embodiment has several degrees of freedom with respect to the spray-orifice geometry. It should be emphasized that such rounded hole shapes or cavities cannot be produced by, e.g., laser machining. Electrode 43 configured according to the present invention allows small cavities 46 be introduced into spray orifice 45, using the ECM method of the present invention.

FIG. 5 shows a workpiece 51 having several spray orifices 55 introduced into it with the aid of the method according to the present invention. Within the scope of large-scale production, several spray orifices 55 may be simultaneously introduced inside the one workpiece 51, using several simultaneously guided electrodes.

Further spray-orifice geometries and spray-orifice shapes may be produced by suitable electrodes.

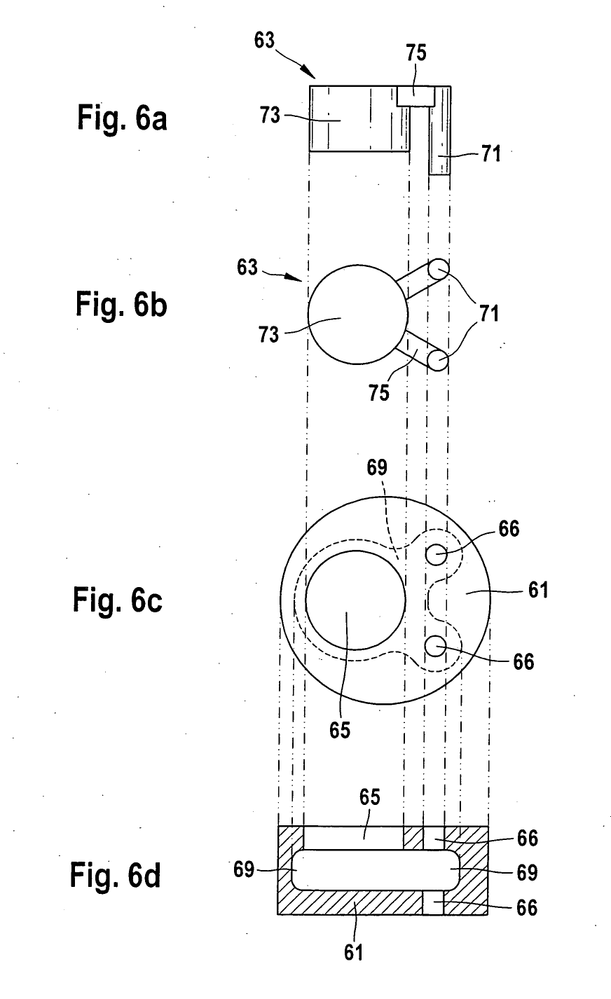

FIG. 6 shows a possible, complexly shaped variant of an electrode 73 of the present invention, viewed once from the side (FIG. 6a) and once from below (FIG. 6b). When implementing the method of the present invention inside a workpiece 61, this electrode 73 allows holes 65, 66 having hollows 69 to be produced for special technical applications.

Electrode 63 has a main body 73 and two pins 71, which are interconnected by two crosspieces 75. In this context, pins 71 are longer than main body 73.

To remove material inside workpiece 61, electrode 63 is lowered down from above while carrying out the ECM process. Holes 66 produced by pins 71 are through-holes inside workpiece 61. Hole 65 produced by main body 73 is only partially introduced into workpiece 61. In this manner, hollows 69 are produced in that electrode 63 is stopped inside workpiece 61, during which time the ECM process is continued.

In this refinement (FIGS. 6c and 6d), holes 65, 66 are connected to mixing and swirl chambers 69 for, e.g. the injection of fuel, in order to divert the jet with the aid of swirl chambers. Holes 65, 66 are sunk in to different depths and/or sunk in from different ends.

1. A method for removing metallic material of a workpiece, comprising:
removing metallic material of a workpiece using the flow of current between an electrode and the workpiece in the presence of an electrolyte;
during the removing, causing a relative movement between the electrode and the workpiece; and
regulating the relative movement and at least one further process parameter as a function of time.

2. The method as recited in claim 1, wherein the relative movement between the electrode and the workpiece is continuous.

3. The method as recited in claim 1, wherein the relative movement between the electrode and the workpiece discontinuous.

4. The method as recited in claim 1, wherein a current flowing between the electrode and the workpiece is regulated as a function of time as the at least one further process parameter.

5. The method as recited in claim 1, wherein a voltage applied between the electrode and the workpiece is regulated as a function of time as the at least one further process parameter.

6. The method as recited in claim 1, wherein the electrode is moved in a direction perpendicular to a surface of the workpiece.

7. The method as recited in claim 1, where at least one hole having a first opening with a first diameter and a second opening with a second diameter is produced inside the workpiece.

8. The method as recited in claim 1, wherein the removing step includes producing a channel for a flowing medium.

9. The method as recited in claim 1, wherein the workpiece is for a fuel injector.

10. A device for removing metallic material of a workpiece using the flow of current between an electrode and the workpiece in the presence of an electrolyte, comprising:
a current/voltage source configured to produce the current flow, the current/voltage source configured to be connected to the electrode and the workpiece;
a reservoir to provide the electrolyte between the electrode and the workpiece;
at least one device for producing a time-dependent relative movement between the electrode and the workpiece; and
at least one device to regulate the current/voltage source as a function of time.

11. The device as recited in claim 10, wherein a time-dependent current is generated by the current/voltage source.

12. The device as recited in claim 11, wherein the electrode is conical in at least some regions.
